(19) United States
(12) Patent Application Publication
(10) Pub. No.: US 2021/0311779 A1
(43) Pub. Date: Oct. 7, 2021

(54) DATA PROCESSING DEVICE, DATA PROCESSING SYSTEM, DATA PROCESSING METHOD, AND PROGRAM

(71) Applicant: Mitsubishi Electric Corporation, Tokyo (JP)

(72) Inventors: Motoyuki OZAKI, Tokyo (JP); Osamu NASU, Tokyo (JP); Ryo KASHIWAGI, Tokyo (JP)

(73) Assignee: Mitsubishi Electric Corporation, Tokyo (JP)

(21) Appl. No.: 17/288,008

(22) PCT Filed: Dec. 27, 2018
(86) PCT No.: PCT/JP2018/048060

§ 371 Date: Apr. 23, 2021

(51) Int. Cl. G06F 9/48; G06F 9/54

(52) U.S. Cl. CPC G06F 9/4881; G06F 9/4856; G06F 9/542

(57) ABSTRACT

A data processing device (10) includes a process controller (141) for outputting process data to undergo a subprocess to a processing unit (131) for performing the subprocess to cause the processing unit (131) to perform the subprocess that is one of subprocesses to be sequentially performed in a process sequence, and a transferrer (142) for transferring the process data output by the process controller (141) to predetermined destinations including the processing unit (131) and another processing unit (130). The process controller (141) outputs, together with the process data, an ID indicating the subprocess to be performed on the process data to the transferrer (142).

### TECHNICAL FIELD

The present disclosure relates to a data processing device, a data processing system, a data processing method, and a program.

### BACKGROUND ART

Production, inspection, and various other processes performed at facilities, typically factories, commonly involve processing of data collected in real time from sites at the facilities (see, for example, Patent Literature 1). Patent Literature 1 describes a technique with a server that collects data from sensors through a gateway device. With this technique, the gateway device performs multiple manipulation processes on such data in accordance with the rules set by the server, and then transmits data representing the processing results to the server. This reduces the load on the server that collects data from many sensors.

### CITATION LIST

### Patent Literature

Patent Literature 1: Unexamined Japanese Patent Application Publication No. 2015-28742

### SUMMARY OF INVENTION

### Technical Problem

Typically, different processes, or possibly complicated processes, may be performed on data in response to user requests. For easier change and extension of such processes on data, the processes may be modularized, and the settings performed by the user may be simplified. However, with the technique described in Patent Literature 1, the server is used to preset all the processes to be performed on data. This may increase the workload on the user.

In response to the above issue, an objective of the present disclosure is to reduce the workload on the user in processing data.

### Solution to Problem

To achieve the above objective, a data processing device according to an aspect of the present disclosure includes control means for outputting process data to undergo a subprocess to first processing means for performing the subprocess to cause the first processing means to perform the subprocess that is one of subprocesses to be sequentially performed in a process sequence, and transfer means for transferring the process data output by the control means to predetermined destinations including the first processing means and another processing means. The control means outputs, together with the process data, process information indicating the subprocess to be performed on the process data.

### Advantageous Effects of Invention

In the apparatus according to the above aspect of the present disclosure, the control means outputs process data to cause the first processing means to perform the subprocess. This allows modularization of the process sequence. The transfer means transfers data output by the control means to predetermined destinations including the first processing means and another processing means. The control means outputs, together with the process data, process information indicating the subprocess to be performed on the process data. Thus, the first processing means and the another processing means can determine whether to perform a subprocess based on the process information. In this structure, the control means can avoid specifying the first processing means as a destination of data, and the first processing means can avoid performing different processes for different sources of data. This allows easier design and simpler setting for the processing means, thus reducing the workload on the user in processing data.

### BRIEF DESCRIPTION OF DRAWINGS

FIG. 1 is a block diagram of a data processing system according to an embodiment of the present disclosure;

FIG. 2 is a block diagram of a data processing device according to the embodiment showing the hardware configuration;

FIG. 3 is a diagram showing the setting of an example process sequence in the embodiment;

FIG. 4 is a functional block diagram of the data processing device according to the embodiment;

FIG. 5 is a diagram describing exchange of data between processing units, a transferrer, and a process controller in the embodiment;

FIG. 6 is a detailed functional block diagram of a processing unit and an implementation controller in the embodiment;

FIG. 7 is a flowchart showing process implementation in the embodiment;

FIG. 8 is an ID replacement table in the embodiment;

FIG. 9 is a flowchart showing process control transmission in the embodiment;

FIG. 10 is a flowchart showing data transfer in the embodiment;

FIG. 11 is a flowchart showing process control reception in the embodiment;

FIG. 12 is a flowchart showing implementation in the embodiment;

FIG. 13 is a functional block diagram of a data processing device according to a modification;

FIG. 14 is a first diagram describing exchange of data between processing units, a transferrer, and a process controller in a modification;

FIG. 15 is a second diagram describing exchange of data between processing units and a process controller in a modification;

FIG. 16 is a diagram showing the setting of an example process sequence in a modification; and

FIG. 17 is a block diagram of a data processing system according to a modification.

### DESCRIPTION OF EMBODIMENTS

A data processing device 10 according to one or more embodiments of the present disclosure will now be described in detail with reference to the drawings.

### Embodiment

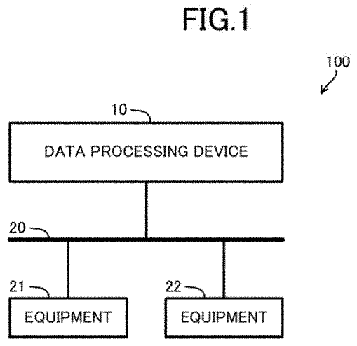

The data processing device 10 according to the present embodiment is, for example, an industrial personal computer (IPC) installed at a factory. As shown in FIG. 1, a data processing system 100 as a factory automation (FA) system includes the data processing device 10 connected to equipment 21 and equipment 22 on a production line in a factory through an industrial network 20. The data processing device 10 processes data collected from the equipment 21 through the network 20, and outputs a control instruction corresponding to the processing result to the equipment 22. The equipment 21 is a sensor. The equipment 22 is an actuator or a robot.

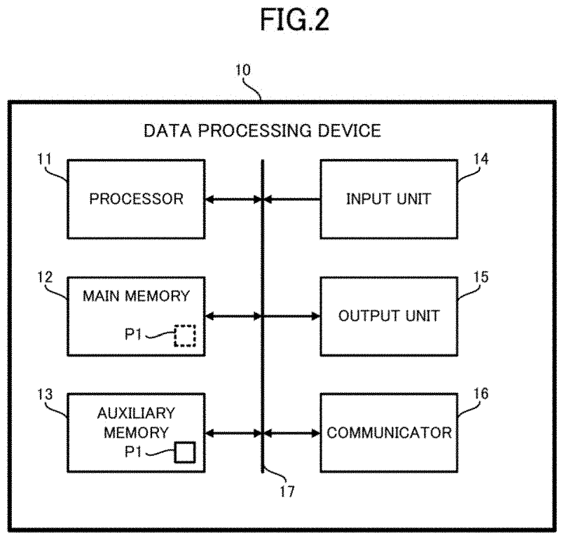

As shown in FIG. 2, the data processing device 10 includes, as hardware components, a processor 11, a main memory 12, an auxiliary memory 13, an input unit 14, an output unit 15, and a communicator 16. The main memory 12, the auxiliary memory 13, the input unit 14, the output unit 15, and the communicator 16 are all connected to the processor 11 with an internal bus 17.

The processor 11 includes a central processing unit (CPU). The processor 11 executes a program P1 stored in the auxiliary memory 13 to implement various functions of the data processing device 10 and perform the processes described later.

The main memory 12 includes a random-access memory (RAM). The main memory 12 stores the program P1 loaded from the auxiliary memory 13. The main memory 12 is used as a work area by the processor 11.

The auxiliary memory 13 includes nonvolatile memories, typically an electrically erasable programmable read-only memory (EEPROM) and a hard disk drive (HDD). The auxiliary memory 13 stores, in addition to the program P1, various data items to be used in the processes performed by the processor 11. The auxiliary memory 13 provides data usable by the processor 11 to the processor 11 as instructed by the processor 11, and stores data provided by the processor 11. Although the single program P1 is stored in the auxiliary memory 13 typically in FIG. 2, multiple programs may be stored in the auxiliary memory 13 or loaded into the main memory 12.

The input unit 14 includes input devices, typically input keys and a pointing device. The input unit 14 acquires information input by the user of the data processing device 10, and provides the acquired information to the processor 11.

The output unit 15 includes output devices, typically a liquid crystal display (LCD) and a speaker. The output unit 15 presents various pieces of information to the user as instructed by the processor 11.

The communicator 16 includes a network interface circuit for communicating with external devices. The communicator 16 receives a signal from an external device and outputs data represented by the signal to the processor 11. The communicator 16 also transmits a signal representing data output by the processor 11 to an external device.

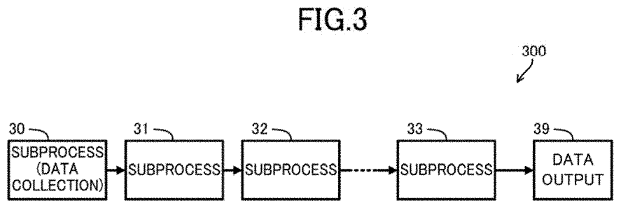

With the hardware components shown in FIG. 2 operating in cooperation, the data processing device 10 performs various functions including processing of data. The processing of data to be performed by the data processing device 10 is defined by the user in any manner into a process sequence 300. The process sequence 300 includes a series of subprocesses 30, 31, 32, and 33 that are sequentially performed as illustrated in FIG. 3.

The process sequence 300 includes subprocesses that are sequentially performed on data output by the equipment 21. More specifically, the process sequence 300 includes the subprocess 30 for collecting data, the subprocess 31, the subprocess 32, the subprocess 33, and data output 39 that are performed in this order. The arrows in FIG. 3 indicate the transfer of data. For example, the subprocess 30 is performed to acquire data from outside the data processing device 10. The data is input into the subprocess 31. The data thus undergoes the subprocess 31. Data representing the processing result of the subprocess 31 is output from the subprocess 31 to the subprocess 32. The data thus undergoes the subprocess 32. Data representing the processing result of the subprocess 33 is output from the subprocess 33 to the data output 39. The data thus undergoes the data output 39 and is output by the data processing device 10.

The subprocess 30 corresponds to a process for receiving data from the equipment 21 through the network 20 shown in FIG. 1 to collect data to be processed. The subprocess 30 is periodically performed in response to the equipment 21 periodically transmitting data representing the sensing result. The subprocess 30 is performed at intervals of, for example, 10 ms, 100 ms, or 1 s. The data representing the sensing result is a digital value of, for example, 8 or 16 bits.

The subprocesses 31 to 33 are performed repeatedly as the subprocess 30 is performed. For example, the subprocess 31 is to calculate a moving average, the subprocess 32 is to determine whether the value to be processed exceeds a predetermined threshold, and the subprocess 33 is to determine the details of a control instruction for the equipment 22 in FIG. 1. Through these subprocesses 31 to 33, the sensing result from which noise is removed is generated using the moving average, and a predetermined control instruction is output in response to the resultant value exceeding the threshold.

The subprocesses 31 to 33 are not limited to the above processes. For example, the subprocesses 31 to 33 may be rounding or normalization for converting a value to fall within a predetermined range, scaling for multiplying an input value by a predetermined constant, shifting for adding a predetermined offset value to an input value, filtering or statistical processing other than a moving average, or transformation, typically a fast Fourier transform (FFT). The subprocesses 31 to 33 may be any other manipulation or diagnosis, or any other processes. Although FIG. 3 shows an example process sequence including the four subprocesses 30 to 33, the process sequence may include three or less or five or more subprocesses.

The data output 39 corresponds to transmission of the processing result of the subprocess 33 to the equipment 22 through the network 20 shown in FIG. 1. However, the data output 39 is not limited to transmission of data to the equipment 22, but may be output of an instruction for executing a preliminarily designated program, display of the result of the process sequence on a screen, transmission of data to another device, or any other output. The example below mainly describes data generated through the process sequence 300 to be output to the equipment 22 as a control instruction.

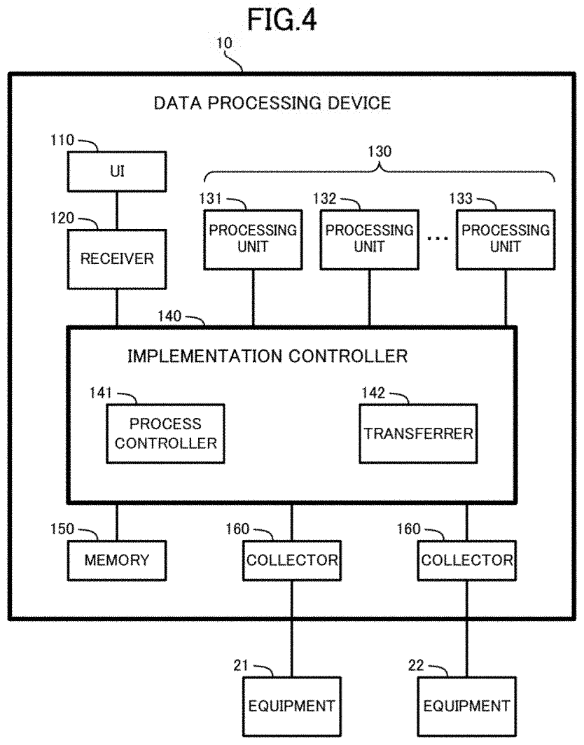

The data processing device 10 includes the functional components as shown in FIG. 4 to perform the process sequence 300 shown in FIG. 3. More specifically, the data processing device 10 includes a user interface (UI) 110 for exchanging information with the user, a receiver 120 for receiving the setting of a process sequence, processing units 131, 132, and 133 for performing subprocesses, an implementation controller 140 for controlling the implementation of the process sequence, a memory 150 for storing various items of data, and a collector 160 for collecting data and outputting a control instruction.

The UI 110 is implemented mainly by the input unit 14 and the output unit 15 operating in cooperation. The UI 110 receives a display instruction from the implementation controller 140 through the receiver 120, and displays a screen prompting the user to input a process sequence in accordance with the display instruction. The user operates the screen being displayed to combine any subprocesses into a process sequence to be performed by the data processing device 10. The UI 110 then provides, to the receiver 120, the setting of the process sequence input by the user.

The receiver 120 is implemented mainly by the processor 11. The receiver 120 receives the setting of the process sequence that defines subprocesses to be sequentially performed on data. The receiver 120 provides the setting of the process sequence to the implementation controller 140. The implementation controller 140 stores, into the memory 150, information indicating the details of the setting of the process sequence.

The processing units 131 to 133 are implemented mainly by the processor 11 and the main memory 12 operating in cooperation, and perform the subprocesses 31 to 33. More specifically, each of the processing units 131 to 133 is implemented by the processor 11 executing a software module stored in the auxiliary memory 13. The software module may be plug-in software stored in the auxiliary memory 13 by the user.

The plug-in software may be designed, purchased, or acquired as open-source software by the user. The processing units 131 to 133 are hereafter collectively referred to as processing units 130. The processing units 130 are examples of first processing means, second processing means, and other processing means for performing subprocesses on data in the data processing device 10.

The processing units 130 may not correspond one-to-one to the subprocesses included in the process sequence 300 shown in FIG. 3. In some embodiments, a subprocess may be performed on data twice. Such two subprocesses may be coupled in the process sequence 300 and performed by the single processing unit 132.

The implementation controller 140 is implemented mainly by the processor 11. The implementation controller 140 mediates the exchange of data between a processing unit 130 and another processing unit 130 to cause the processing units 130 to perform subprocesses in the order corresponding to the set process sequence. The implementation controller 140 includes a process controller 141 for determining a subprocess to be performed on data based on the setting of the process sequence to control a flow of data, and a transferrer 142 for relaying data between the processing units 130 and the process controller 141.

The process controller 141 acquires data collected by the collector 160 and outputs this data to the processing unit 131 through the transferrer 142 to cause the processing unit 131 to perform a subprocess. The process controller 141 also acquires data representing the result of a subprocess from a processing unit 130 through the transferrer 142 and outputs this data to another processing unit 130 through the transferrer 142 to cause the other processing unit 130 to perform the next subprocess. The process controller 141, when acquiring data representing the result of the last subprocess from the processing unit 133 through the transferrer 142, outputs this data to the collector 160 as a control instruction to be transmitted to the equipment 22. In some embodiments, the output set as an output of the result of the process sequence is different from transmission of the control instruction to the equipment 22. The process controller 141 then performs a process for implementing the set output. In some embodiments, the process sequence may be set to display the result on the screen. The process controller 141 may then output data for causing the output unit 15 including an LCD to display the result. The process controller 141 is an example of control means for causing a processing unit 130 to perform a subprocess in the data processing device 10.

The transferrer 142 functions as a server. The transferrer 142 transfers data output by each processing unit 130 to the process controller 141, and transfers data output by the process controller 141 to multiple processing units 130 as predetermined destinations. More specifically, the transferrer 142 transfers data in accordance with the publish-subscribe model. The process controller 141 is preset to subscribe data published by each processing unit 130 for any process sequences. All the processing units 130 are preset to subscribe data published by the process controller 141 for any process sequences. The transferrer 142 transfers data from the process controller 141 to many unspecified processing units 130 without designating destinations. Each processing unit 130 determines whether to perform a subprocess on the transferred data based on information (described later) transferred together with the data. The transferrer 142 is an example of transfer means for transferring data output by the control means to predetermined destinations in the data processing device 10.

More specifically, the transferrer 142 has a predetermined setting for subscription determining the destinations to which the transferrer 142 transfers data. The subscription may be set before shipment of the data processing device 10 or may be set by the user of the data processing device 10 in any manner before the process sequence is performed. The setting for subscription may include setting a topic. For certain topic settings, not all the processing units 130 may subscribe data published by the process controller 141. In some embodiments, the data processing device 10 may perform multiple different process sequences in parallel, and the different process sequences may have different topics. More specifically, processing units A, B, and C as examples of the processing units 130 may sequentially perform subprocesses to implement a first process sequence, and processing units D, E, and F as examples of the processing units 130 may sequentially perform subprocesses to implement a second process sequence. In this case, the topic may define the transferrer 142 to deliver data output by the process controller 141 to the processing units A, B, and C for the first process sequence, and to deliver data output by the process controller 141 to the processing units D, E, and F for the second process sequence. Data transferred from the processing units 130 to the process controller 141 is typically directed to the process controller 141 alone. The topic may thus define the process controller 141 as a different destination for each process sequence or as the same destination.

The memory 150 is implemented mainly by the main memory 12. The memory 150 includes a storage area for storing information indicating the setting of the process sequence received by the receiver 120, and a storage area to be a buffer used by the implementation controller 140.

The collector 160 is implemented mainly by the communicator 16. The collector 160 performs the subprocess 30 shown in FIG. 3. More specifically, the collector 160 outputs, to the implementation controller 140, information transmitted repeatedly from the equipment 21. The collector 160 performs the data output 39 shown in FIG. 3. More specifically, the collector 160 transmits, to the equipment 22, the control instruction output by the implementation controller 140.

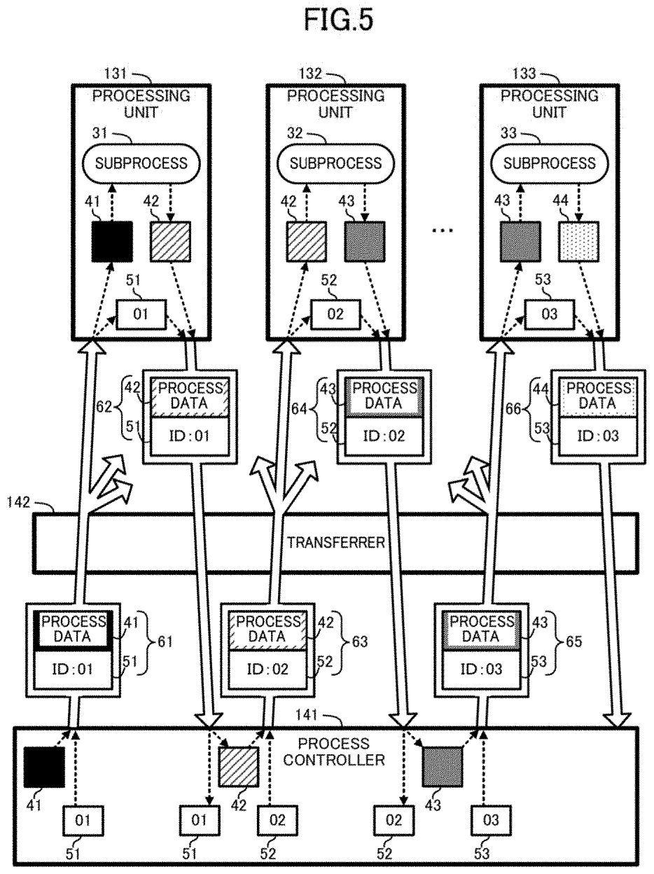

The exchange of information between the processing units 130 and the implementation controller 140 will now be described with reference to FIG. 5. As shown in FIG. 5, the process controller 141 outputs data to undergo a subprocess, together with an identifier (ID) as process information indicating the subprocess to be performed on the data. Each processing unit 130 outputs data representing the result of the subprocess, together with an ID as previous process information indicating the subprocess performed on the data. In FIG. 5, the ID is identification information for identifying a subprocess. The respective subprocesses 31 to 33 correspond to IDs of 01 to 03.

More specifically, the process controller 141 adds an ID 51 of 01 to process data 41 to undergo the subprocess 31, and outputs the resultant data to the transferrer 142. Data to undergo the subprocess and data representing the result of the subprocess are hereafter referred to as process data as appropriate, and information including the process data and the ID is hereafter referred to as transfer data as appropriate. In other words, the process controller 141 outputs transfer data 61 including the process data 41 and the ID 51 to the transferrer 142. The transfer data 61 includes the ID identifying the subprocess, but may not include information identifying the processing unit 131 as a destination or information identifying the process controller 141 as a source. The transferrer 142 transfers the transfer data 61 to all the processing units 131 to 133.

The processing units 132 and 133 to perform the respective subprocesses 32 and 33, different from the subprocess 31 indicated by the ID 51 in the transfer data 61 acquired from the transferrer 142, discard the transfer data 61. More specifically, the processing units 132 and 133 have preset IDs of 02 and 03 indicating the corresponding subprocesses 32 and 33. With the IDs different from the ID 51 in the transfer data 61, the processing units 132 and 133 discard the transfer data 61. The processing unit 131 to perform the subprocess 31 indicated by the ID 51 in the transfer data 61 performs the subprocess 31 on the process data 41 included in the transfer data 61.

The processing unit 131 then generates transfer data 62 by adding the ID 51 to process data 42 representing the result of the subprocess 31, and outputs the transfer data 62 to the transferrer 142. The transferrer 142 transfers the transfer data 62 to the process controller 141. The process controller 141 acquiring the transfer data 62 specifies the subprocess 32 to be performed next in accordance with the set process sequence, and replaces the ID 51 in the transfer data 62 with an ID 52 of 02 indicating the specified subprocess 32. The process controller 141 then outputs transfer data 63 resulting from the replacement to the transferrer 142.

The transferrer 142 then transfers the transfer data 63 to the processing units 131 to 133. The processing units 131 and 133 discard the transfer data 63. The processing unit 132 performs the subprocess 32 on the process data 42 included in the transfer data 63 to generate process data 43. The processing unit 132 adds the ID 52 to the process data 43 to generate transfer data 64, and outputs the transfer data 64 to the transferrer 142. The transferrer 142 then transfers the transfer data 64 to the process controller 141. The process controller 141 then adds an ID 53 indicating the next subprocess 33 to the process data 43 to generate transfer data 65, and outputs the transfer data 65. The processing unit 133 then performs the subprocess 33 on the process data 43 to generate process data 44, adds the ID 53 to the process data 44 to generate transfer data 66, and transfers the transfer data 66 back to the process controller 141.

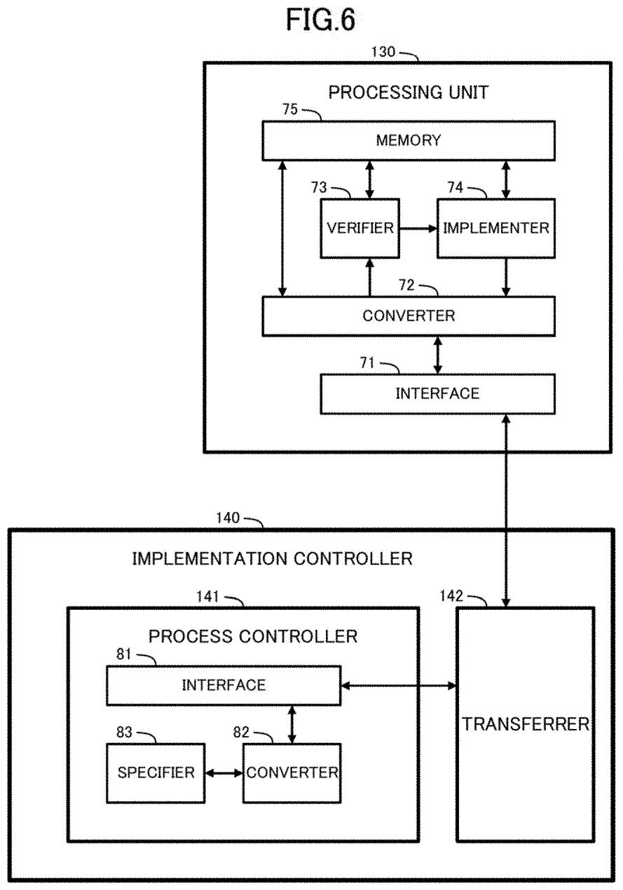

The functional components in each processing unit 130 and the implementation controller 140 for implementing the data exchange as shown in FIG. 5 will now be described in detail with reference to FIG. 6.

As shown in FIG. 6, the processing unit 130 includes an interface 71 for communicating with the transferrer 142, a converter 72 for converting transfer data to and from process data, a verifier 73 for verifying an ID to determine whether to perform a subprocess on process data, an implementer 74 for performing a subprocess, and a memory 75 for storing a set value for an ID to be added to process data to be processed.

The memory 75 may have substantially the same structure as or a structure different from the memory 150 shown in FIG. 4.

The converter 72 receives transfer data through the interface 71, separates the ID from the transfer data, and provides the separated ID to the verifier 73. The converter 72 also stores, into the memory 75, the process data resulting from separation of the ID from the transfer data. The verifier 73 reads the value of a preset ID from the memory 75, and compares the read value with the ID provided by the converter 72. When the IDs do not match, the verifier 73 discards the provided ID and the process data stored in the memory 75. When the IDs match, the verifier 73 causes the implementer 74 to perform the subprocess. Upon receiving an instruction for performing the subprocess from the verifier 73, the implementer 74 reads the process data from the memory 75, generates new process data representing the result of the subprocess performed on the process data, and outputs the new process data to the converter 72. The converter 72 combines an ID with the process data output by the implementer 74 to generate transfer data, and transmits the transfer data to the transferrer 142 through the interface 71. The ID separated from transfer data is equal to the set value for the ID stored in the memory 75, and thus either of the separated ID and the set value for the ID may be combined with the process data.

The process controller 141 includes an interface 81 for communicating with the transferrer 142, a converter 82 for converting transfer data to and from process data, and a specifier 83 for specifying the next subprocess to be performed on the process data. The converter 82 and the specifier 83 use the memory 150 shown in FIG. 4 as appropriate.

Upon receiving transfer data through the interface 81, the converter 82 separates the ID from the transfer data, and provides the separated ID to the specifier 83. The specifier 83 reads the setting of the process sequence from the memory 150, acquires the ID indicating the subprocess next to the subprocess indicated by the provided ID, and provides the acquired ID to the converter 82. The converter 82 combines the process data separated from the transfer data with the ID provided by the specifier 83 to generate transfer data, and transmits the transfer data to the transferrer 142 through the interface 81.

At the start of the process sequence, the converter 82 combines the process data acquired from the collector 160 with the ID corresponding to the subprocess to be performed first to generate transfer data. At the end of the process sequence, the converter 82 outputs process data separated from transfer data to the collector 160 as a control instruction for the equipment 22. In some embodiments, the output may be set different from transfer of the control instruction to the equipment 22. The converter 82 then transmits process data to the destination to perform the output. For example, when the process sequence is set to display the result, the converter 82 may transmit process data to the UI 110. In this case, the implementation controller 140 may manipulate the process data for display on a screen and then output the manipulated data to the UI 110.

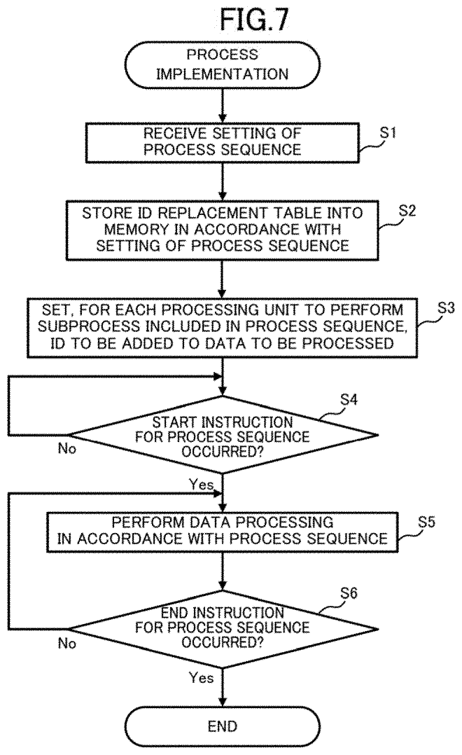

The processing performed by the data processing device 10 will now be described with reference to FIGS. 7 to 12. FIG. 7 shows process implementation for performing a process sequence. This process implementation starts in response to the data processing device 10 being powered on.

In the process implementation, the data processing device 10 receives the setting of a process sequence (step S1). More specifically, the receiver 120 receives the setting of a process sequence input on the UI 110.

The data processing device 10 then generates an ID replacement table in accordance with the setting of the process sequence and stores the ID replacement table into the memory 150 (step S2). More specifically, the implementation controller 140 uses the setting of the process sequence received in step S1 to generate an ID replacement table to be referred to by the process controller 141 for replacing the ID of transfer data.

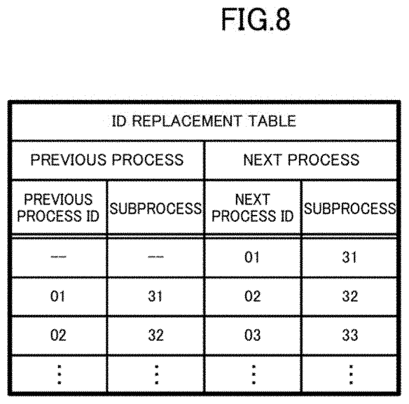

As illustrated in FIG. 8, the ID replacement table is information indicating the correspondence between the previous process that is a subprocess included in the process sequence and the next process that is another subprocess to be performed next to the subprocess. More specifically, the ID replacement table is table data associating the ID of the previous process, the name of the subprocess as the previous process, the ID of the next process, and the name of the subprocess as the next process. In FIG. 8, the name of the subprocess is the same as the reference numeral of the subprocess. The ID replacement table may exclude the name of the subprocess.

Referring back to FIG. 7, following step S2, the data processing device 10 sets, for each processing unit 130 to perform a subprocess included in the process sequence, an ID to be added to the process data to be processed (step S3). More specifically, the implementation controller 140 provides, to each processing unit 130, the ID corresponding to the subprocess to be performed by the processing unit 130, and causes the processing unit 130 to store the ID as a set value into the memory 75 shown in FIG. 6. For example, the implementation controller 140 sets an ID value of 01 for the processing unit 131 to perform the subprocess 31. Thus, each processing unit 130 shares, with the process controller 141, the ID of the subprocess to be performed by the processing unit 130.

The data processing device 10 then determines whether a start instruction for starting the process sequence has occurred (step S4). The start instruction may be a user instruction input on the UI 110, acquisition of specific data with the collector 160, or a trigger generated by the implementation controller 140 at a predetermined time.

When determining that no start instruction has occurred (No in step S4), the data processing device 10 repeats the determination in step S4 and waits until a start instruction occurs. When determining that a start instruction has occurred (Yes in step S4), the data processing device 10 performs data processing in accordance with the process sequence (step S5). More specifically, the subprocesses are sequentially performed with the collector 160 collecting data and with the process controller 141, the transferrer 142, and each processing unit 130 exchanging data.

The data processing device 10 then determines whether an end instruction for ending the process sequence has occurred (step S6). Similarly to the start instruction, the end instruction may be a user instruction, acquisition of specific data with the collector 160, or a trigger generated by the implementation controller 140.

When determining that no end instruction has occurred (No in step S6), the data processing device 10 repeats the processing in step S5 and continues the data processing. When determining that an end instruction has occurred (Yes in step S6), the data processing device 10 ends the process implementation.

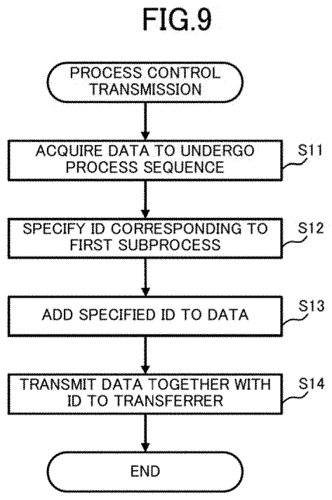

Process control transmission performed by the process controller 141 will now be described with reference to FIG. 9. In the process control transmission, the process controller 141 transmits data to undergo a process sequence to the transferrer 142 to start the process sequence about the data. The process control transmission is included in the data processing performed in step S5 in FIG. 7.

In the process control transmission, the process controller 141 acquires data to undergo a process sequence (step S11). More specifically, the process controller 141 acquires data from the collector 160.

The process controller 141 then specifies the ID corresponding to the first subprocess included in the process sequence (step S12). More specifically, the specifier 83 reads the ID replacement table from the memory 150 and specifies the ID corresponding to the first subprocess 31.

The process controller 141 then adds the specified ID to the data (step S13). More specifically, the converter 82 combines the ID specified in step S12 with the process data acquired in step S11 to generate transfer data.

The process controller 141 then transmits the data together with the ID to the transferrer 142 (step S14). More specifically, the converter 82 outputs the transfer data generated in step S13 to the transferrer 142 through the interface 81. The process control transmission is then complete. The process controller 141 performs the above process control transmission in response to every output of data from the collector 160.

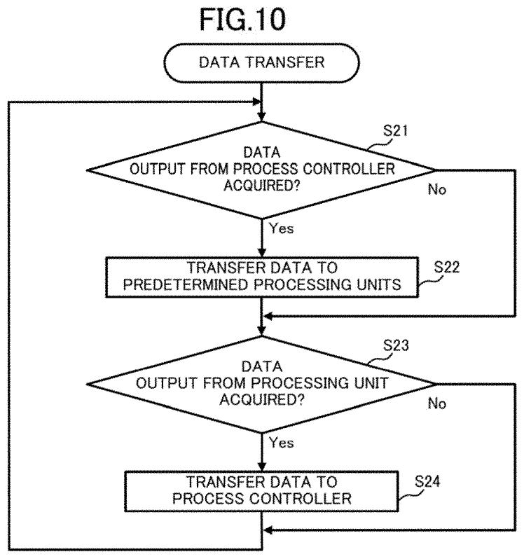

Data transfer performed by the transferrer 142 will now be described with reference to FIG. 10. In the data transfer, the transferrer 142 transfers data between a processing unit 130 and the process controller 141. The data transfer is included in the data processing performed in step S5 in FIG. 7.

In the data transfer, the transferrer 142 determines whether the transferrer 142 has acquired data output by the process controller 141 (step S21). When determining that the transferrer 142 has not acquired data (No in step S21), the transferrer 142 advances the processing to step S23. When determining that the transferrer 142 has acquired data (Yes in step S21), the transferrer 142 transfers the acquired data to predetermined processing units 130 (step S22). More specifically, the transferrer 142 transfers the transfer data acquired from the process controller 141 to all the processing units 130.

The transferrer 142 then determines whether the transferrer 142 has acquired data output by any of the processing units 130 (step S23). When determining that the transferrer 142 has not acquired data (No in step S23), the transferrer 142 repeats the processing in step S21 and subsequent steps. When determining that the transferrer 142 has acquired data (Yes in step S23), the transferrer 142 transfers the acquired data to the process controller 141 (step S24). The transferrer 142 then repeats the processing in step S21 and subsequent steps. In response to every output of transfer data from any of the processing units 130 and the process controller 141, the transferrer 142 transfers the transfer data.

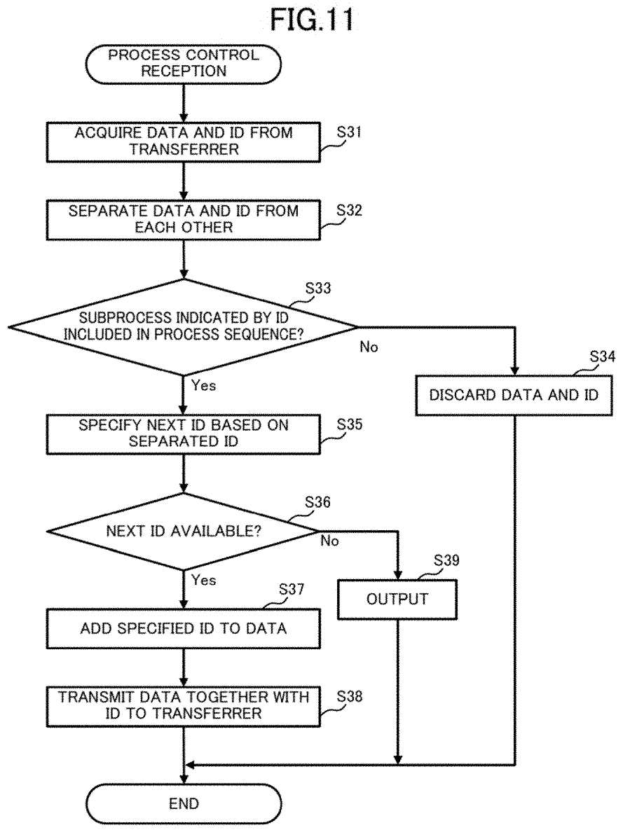

Process control reception performed by the process controller 141 will now be described with reference to FIG. 11. The process control reception starts in response to the process controller 141 receiving data from a processing unit 130. The process control reception is included in the data processing performed in step S5 in FIG. 7.

In the process control reception, the process controller 141 acquires data and an ID from the transferrer 142 (step S31). More specifically, the converter 82 receives transfer data including process data and an ID from the transferrer 142 through the interface 81.

The process controller 141 then separates the data and the ID from each other (step S32). More specifically, the converter 82 extracts each of the process data and the ID included in the transfer data.

The process controller 141 then determines whether the subprocess indicated by the ID is included in the process sequence (step S33). More specifically, the specifier 83 reads the ID replacement table from the memory 150 and determines whether the ID separated in step S32 is included in the ID replacement table as the ID of a previous process.

When determining that the subprocess indicated by the ID is not included in the process sequence (No in step S33), the process controller 141 discards the data and the ID (step S34). The process control reception is then complete. When determining that the subprocess indicated by the ID is included in the process sequence (Yes in step S33), the process controller 141 specifies the next ID based on the separated ID (step S35). More specifically, the specifier 83 specifies the ID of the next process associated with the ID separated in step S32 in the ID replacement table.

The process controller 141 then determines whether the next ID is available (step S36). More specifically, the process controller 141 determines whether the specifier 83 has specified the ID of the next process associated with the ID separated in step S32.

When determining that the next ID is unavailable (No in step S36), the process controller 141 determines that the process sequence has ended, and performs an output (step S39). For example, the specifier 83 determines that the process data separated in step S32 is the result of the last subprocess in the process sequence, and outputs the process data to the collector 160. The process control reception is then complete.

When determining that the next ID is available (Yes in step S36), the process controller 141 adds the specified ID to the data (step S37). More specifically, the converter 82 combines the process data separated in step S32 with the next ID specified in step S35 to generate transfer data.

The process controller 141 then transmits the data together with the ID to the transferrer 142 (step S38). More specifically, the converter 82 outputs the transfer data generated in step S37 to the transferrer 142 through the interface 81. The process control reception is then complete. The above process control reception is performed in response to every transfer of data from the transferrer 142 to the process controller 141.

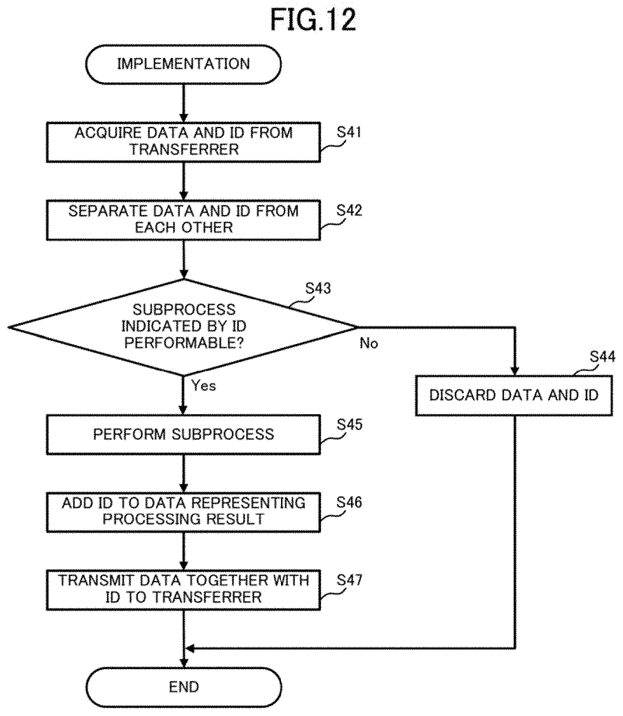

Implementation performed by each processing unit 130 will now be described with reference to FIG. 12. The implementation involves performing a subprocess and starts in response to the processing unit 130 receiving data from the process controller 141. The implementation is included in the data processing performed in step S5 in FIG. 7.

In the implementation, the processing unit 130 acquires data and an ID from the transferrer 142 (step S41). More specifically, the converter 72 receives transfer data including process data and an ID from the transferrer 142 through the interface 71.

The processing unit 130 then separates the data and the ID from each other (step S42). More specifically, the converter 72 extracts each of the process data and the ID included in the transfer data.

The processing unit 130 then determines whether the subprocess indicated by the ID can be performed (step S43). More specifically, the verifier 73 reads the set value for the ID from the memory 75, and determines whether the ID separated in step S42 is equal to the read set value.

When determining that the subprocess indicated by the ID cannot be performed (No in step S43), the processing unit 130 discards the data and the ID (step S44). The implementation is then complete. When determining that the subprocess indicated by the ID can be performed (Yes in step S43), the processing unit 130 performs the subprocess (step S45). More specifically, the implementer 74 performs the subprocess on the process data separated in step S42 to generate new process data representing the processing result.

The processing unit 130 then adds the ID to the data representing the processing result (step S46). More specifically, the converter 72 combines the ID separated in step S42 with the process data generated in step S45 to generate transfer data.

The processing unit 130 then transmits the data together with the ID to the transferrer 142 (step S47). More specifically, the converter 72 outputs the transfer data generated in step S46 to the transferrer 142. The implementation is then complete. The above implementation is performed in response to every transfer of data from the transferrer 142 to the processing unit 130.

As described above, the process controller 141 outputs process data to cause a processing unit 130 to perform a subprocess. This allows modularization of the process sequence.

The transferrer 142 transfers the process data output by the process controller 141 to predetermined destinations including the multiple processing units 130. The process controller 141 outputs the process data together with an ID as process information indicating the subprocess to be performed on the process data.

Thus, each processing unit 130 can determine whether to perform a subprocess based on the ID. Thus, the process controller 141 can avoid specifying any processing unit 130 as a destination of process data, and each processing unit 130 can avoid performing different processes for different sources of process data. This allows easier design and simpler setting for each processing unit 130, thus reducing the workload on the user in processing data. This also allows easier change and extension of the process sequence.

In response to acquiring process data together with an ID from the transferrer 142, the process controller 141 specifies the ID corresponding to the next subprocess in accordance with the setting of the process sequence, and outputs the process data together with the specified ID to the transferrer 142. This allows the subprocesses to be sequentially performed in accordance with the setting of the process sequence.

The transferrer 142 transfers, to the process controller 141, process data and an ID as previous process information indicating another subprocess that are output by another processing unit that performs the other subprocess before a processing unit 130 performs a subprocess. In response to acquiring the process data and the ID from the transferrer 142, the process controller 141 refers to the ID replacement table to specify the ID indicating the subprocess to be performed next based on the ID as previous process information and in accordance with the set process sequence. The process controller 141 then outputs the acquired process data together with the specified ID. Thus, the process controller 141 that has received process data adds an appropriate ID to this data and then outputs the resultant data. The ID replacement table may be set before implementation of the process sequence. This allows the process controller 141 to provide an appropriate ID to process data.

The transferrer 142 transfers data to predetermined destinations. More specifically, the transferrer 142 transfers process data and an ID in accordance with the publish-subscribe model. Thus, the processing units 130 and the process controller 141 can avoid performing different processes for different sources or destinations of process data. The change of setting of the process sequence for preparing for a new process sequence can be achieved simply by applying the setting of the process sequence to the implementation controller 140 and changing the ID set values in the ID replacement table and for the processing units 130. The process sequence can be changed easily, without changing the details of the subprocesses to be performed by the processing units 130.

The transferrer 142 transfers data output by the process controller 141 to all the processing units 130 to perform the subprocesses included in the process sequence. This allows easy setting of the destinations to which the transferrer 142 transfers data.

In response to acquiring data directed to a processing unit 130 as a destination together with the ID indicating the subprocess to be performed on the data, the processing unit 130 determines whether to perform the subprocess using the acquired ID. Thus, the processing unit 130 can perform the subprocess on appropriate data.

The ID transferred together with process data indicates a subprocess included in the process sequence, rather than indicating the processing unit 130 to perform the subprocess. Thus, for example, the process sequence shown in FIGS. 3 and 5 can be changed to include two subprocesses 31 to be consecutively performed for preparing for a new process sequence simply by setting set values of 01 and 02 for the ID of the processing unit 131.

The transferrer 142 is an example of transfer means for transferring data output by the control means to predetermined destinations including the first processing means and other processing means, and for transferring data output by the second processing means to the control means. The processing unit 130 corresponding to the first processing means may be the same as or different from the processing unit 130 corresponding to the second processing means. The processing unit 130 corresponding to the second processing means may be the same as or different from the processing unit 130 corresponding to the other processing means.

Although the embodiment of the present disclosure has been described above, the present disclosure is not limited to the above embodiment.

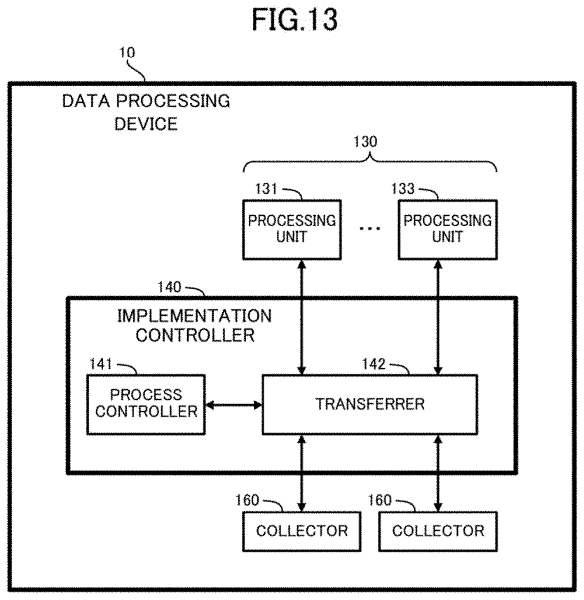

For example, although the transferrer 142 relays communication between the processing units 130 and the process controller 141 in the above embodiment, the transferrer 142 may relay any other communication. As shown in FIG. 13, the transferrer 142 may relay data between the processing units 130, the process controller 141, and the collector 160. For exchanging data between the transferrer 142 and the collector 160, the process sequence may incorporate the subprocess 30 and the data output 39 shown in FIG. 3, and the collector 160 may perform the subprocess 30 and the data output 39 in the same manner as the processing units 130 performing the subprocesses 31 to 33. The collector 160 may exchange transfer data including IDs with the transferrer 142 in the same manner as the processing units 130. In this case, any of the multiple subprocesses included in the process sequence includes at least one of collecting equipment data from the equipment 21 or transmitting transmission data to the equipment 22. The equipment data as used herein refers to data including information output by the equipment 21, and the transmission data refers to data including information to be transmitted to the equipment 22.

The data processing device 10 may include the transferrer 142 for relaying communication between the processing units 130 and the process controller 141, and another transferrer for relaying communication with the collector 160.

In the above embodiment, the transferrer 142 distinguishes between transferring data from the process controller 141 to each processing unit 130 and transferring data from each processing unit 130 to the process controller 141. In some embodiments, the transferrer 142 may use all of the process controller 141 and the processing units 130 as equal nodes, and may transfer data output from one node to all the other nodes.

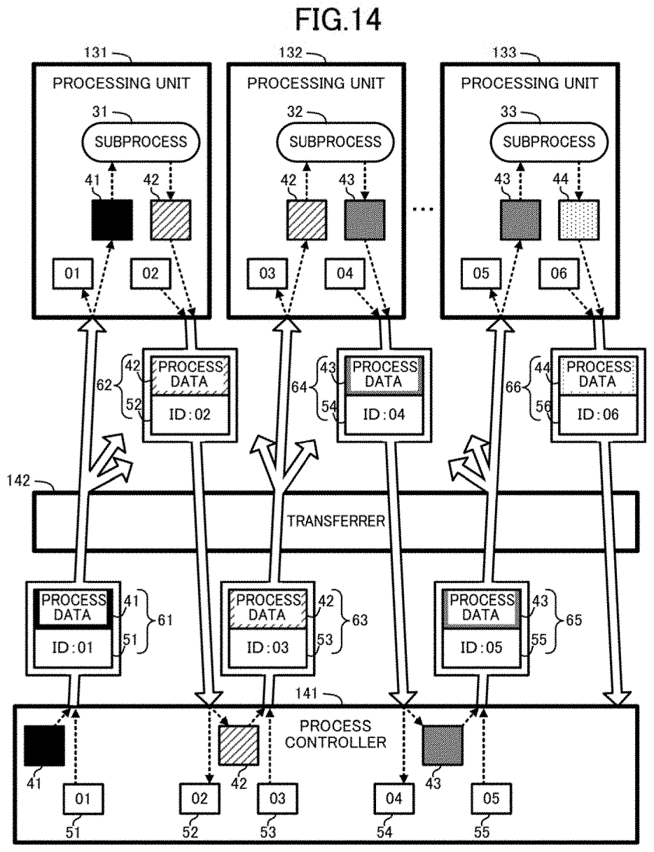

In the above embodiment, the processing unit 130 outputs transfer data including an ID identical to the ID included in transfer data that the processing unit 130 has acquired. In some embodiments, as shown in FIG. 14, the processing unit 130 may output transfer data including an ID different from the ID in acquired transfer data. The process controller 141 may preassign, for the processing unit 130, an ID to process data to be transmitted by the processing unit 130. The processing unit 130 can then output process data with an ID different from an acquired ID.

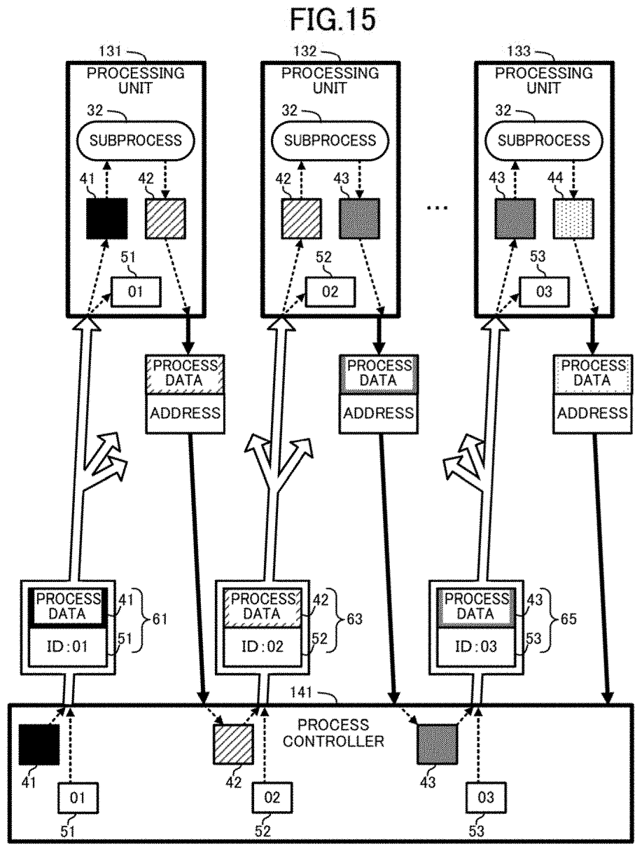

In the above embodiment, the transferrer 142 transfers data in accordance with the publish-subscribe model bidirectionally between the process controller 141 and the processing units 130. In some embodiments, as shown in FIG. 15, the transferrer 142 may transfer data from the process controller 141 to each processing unit 130 in accordance with the publish-subscribe model, and transfer data in the opposite direction in accordance with a one-to-one communication protocol other than a protocol in the publish-subscribe model. In this case, process data transferred from each processing unit 130 to the process controller 141 has an address instead of an ID.

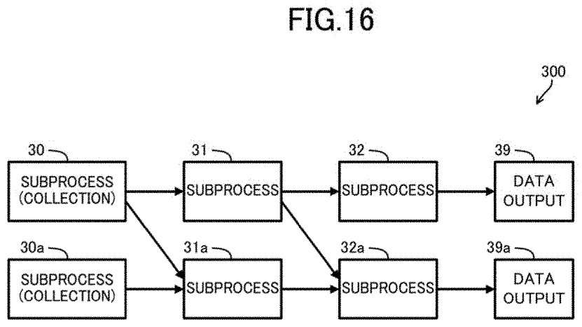

In the above embodiment, the process sequence is relatively simple as shown in FIG. 3. In some embodiments, the process sequence may be more complicated. For example, as shown in FIG. 16, the process sequence may have the subprocess 30 branching into subprocesses 31 and 31a and a subprocess 32a joined from subprocesses 31 and 31a.

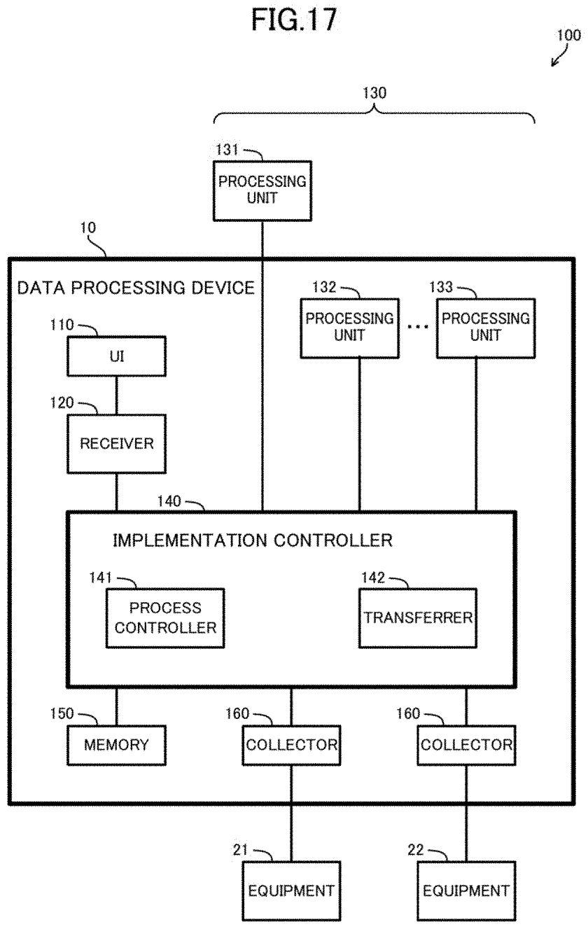

In the above embodiment, the processing units 130 are included in the data processing device 10. In some embodiments, as shown in FIG. 17, the data processing system 100 may include the processing unit 131 external to the data processing device 10.

In the above embodiment, each processing unit 130 has one ID. In some embodiments, each processing unit 130 may have the memory 75 storing multiple set values for the ID. In step S43 in FIG. 12, the verifier 73 may then determine whether the received ID matches any of the set values. In some embodiments, a process sequence may include multiple subprocesses performable by one processing unit 130. In other embodiments, multiple process sequences to be simultaneously performed include a subprocess performable by one processing unit 130. In any of these embodiments, the processing unit 130 can perform the subprocess or subprocesses.

In the above embodiment, the ID is information for identifying a subprocess. In some embodiments, the ID may be any other information that uniquely identifies the source, the destination, and any other attribute or type of data, or a combination of two or more of them.

The functions of the data processing device 10 can be implementable by dedicated hardware or a common computer system.

For example, the program P1 executable by the processor 11 may be stored in a non-transitory computer-readable recording medium for distribution. The program P1 is installed in a computer to provide a device that performs the above processing. Examples of such recording media include a flexible disk, a compact disc read-only memory (CD-ROM), a digital versatile disc (DVD), and a magneto-optical (MO) disk.

The program P1 may be stored in a disk unit included in a server on a communication network, typically the Internet, and may be, for example, superimposed on a carrier wave to be downloaded to a computer.

The processing described above may also be performed by the program P1 being activated and executed while being transferred through a communication network.

The processing described above may also be performed by the program P1 being entirely or partially executed on a server with a computer transmitting and receiving information about the processing through a communication network.

In the system with the above functions implemented partly by an operating system (OS) or through cooperation between the OS and applications, portions related to the part other than the OS may be stored in a medium for distribution or may be downloaded to a computer.

Means for implementing the functions of the data processing device 10 is not limited to software. The functions may be partly or entirely implementable by dedicated hardware including circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for data processing.

### REFERENCE SIGNS LIST

100 Data processing system
10 Data processing device
11 Processor
12 Main memory
13 Auxiliary memory
14 Input unit
15 Output unit
16 Communicator
17 Internal bus
110 UI
120 Receiver
130 to 133 Processing unit
140 Implementation controller
141 Process controller
142 Transferrer
150 Memory
160 Collector
20 Network
21, 22 Equipment
300 Process sequence
30 to 33, 31a, 32a Subprocess
39 Data output
41 to 44 Process data
61 to 66 Transfer data
71 Interface
72 Converter
73 Verifier
74 Implementer
75 Memory
81 Interface
82 Converter
83 Specifier
P1 Program

1. A data processing device comprising:
a controller to output process data to undergo a subprocess to a first processing unit that performs the subprocess to cause the first processing unit to perform the subprocess, the subprocess being one of subprocesses to be sequentially performed in a process sequence; and
a transferrer to transfer the process data output by the controller to predetermined destinations including the first processing unit and another processing unit,
wherein the controller outputs, together with the process data, process information indicating the subprocess to be performed on the process data.

2. The data processing device according to claim 1, wherein
the transferrer transfers, to the controller, the process data and previous process information indicating another subprocess, and the process data and the previous process information are output by a second processing unit that performs the another subprocess before the first processing unit performs the subprocess, and
in response to acquiring the process data and the previous process information, the controller specifies the process information based on the previous process information in accordance with the process sequence, and outputs the specified process information together with the acquired process data.

3. The data processing device according to claim 1, wherein
the transferrer transfers the process data and the process information in accordance with a publish-subscribe model.

4. The data processing device according to claim 1, wherein
the transferrer transfers the process data output by the controller to all processing units that perform the subprocesses included in the process sequence.

5. The data processing device according to claim 1, wherein
the data processing device is connectable to equipment, and
one of the subprocesses included in the process sequence includes at least one of collecting equipment data from the equipment or transmitting transmission data to the equipment.

6. A data processing system comprising:
a processing unit that performs a subprocess being one of subprocesses to be sequentially performed in a process sequence; and
the data processing device according to claim 1 configured to cause the processing unit to perform the subprocess.

7. The data processing system according to claim 6, wherein
the data processing device outputs, together with process data to undergo the subprocess, process information indicating the subprocess to be performed on the process data, and
in response to acquiring the process data and the process information, the processing unit determines whether to perform the subprocess based on the acquired process information.

8. (canceled)

9. A non-transitory computer-readable recording medium storing a program for causing a computer to function as
a controller to output process data to undergo a subprocess to a processing unit that performs the subprocess to cause the processing unit to perform the subprocess, the subprocess being one of subprocesses to be sequentially performed in a process sequence, and
a transferrer to transfer the process data output by the controller to predetermined destinations including the processing unit and another processing unit,
wherein the controller outputs, together with the process data, process information indicating the subprocess to be performed on the process data.
